(19) United States
(12) Patent Application Publication
(10) Pub. No.: US 2025/0312950 A1
(43) Pub. Date: Oct. 9, 2025

(54) APPARATUS AND METHOD FOR COMPRESSION MOULDING CONCAVE OBJECTS

(71) Applicant: SACMI COOPERATIVA MECCANICI IMOLA SOCIETA' COOPERATIVA, IMOLA (IT)

(72) Inventors: GIANLUCA ALDIGERI, IMOLA (IT); DAVIDE BALDISSERRI, IMOLA (IT); MATTEO FAZZIANI, IMOLA (IT); NICOLA RINALDI CERONI, CASOLA VALSENIO (IT)

(21) Appl. No.: 18/865,072

(22) PCT Filed: May 16, 2023
(86) PCT No.: PCT/IB2023/055007

§ 371 Date: Nov. 12, 2024

(30) Foreign Application Priority Data
May 23, 2022 (IT) 102022000010631

(51) Int. Cl. B29C 43/34; B29C 35/16; B29C 43/02; B29C 43/52; B29L 31/00

(52) U.S. Cl. CPC B29C 43/34; B29C 35/16; B29C 43/02; B29C 43/52; B29C 2035/1616; B29C 2043/3433; B29C 2043/3466; B29L 2031/712

(57) ABSTRACT

An apparatus that includes a dispensing device for dispensing doses of polymeric material suitable for compression moulding; a mould for receiving doses and making concave objects; a plurality of transport elements of respective doses for releasing doses to the mould; and a carousel for supporting the transport elements for feeding each element in an advancement direction (A) and along a closed path between the dispensing device and the mould. The transport element includes a wall for engaging the dose rotatably mounted on the carousel between a picking up condition and a condition for releasing the dose such that the wall is overturned with a contact surface facing the mould for releasing the dose in the mould by gravity; and wherein it includes cooling means of each transport element for cooling the element at least in a zone of the closed path.

This invention relates to an apparatus and a method for compression moulding concave objects, such as containers of any type, such as, for example, bottles, glasses, jars or bowls.

In particular, the apparatus is used for the production of concave objects made with a single or multilayer material, starting from any polymeric material which can be subjected to compression moulding.

As is known, the apparatuses for producing objects by compression moulding dosed quantities of polymeric material comprise an extruder for dispensing a polymeric material and a plurality of moulds, each of which comprises a male element equipped with a punch and a female element equipped with a cavity. The prior art apparatuses also comprise a plurality of transport elements mounted on suitable carousels and each of which is configured to transport a dose of polymeric material from the extruder to a mould.

The dose of polymeric material, after having been severed from the extruder, is picked up and fed to the mould, typically above the male element. Subsequently, the male element and the female element are moved towards each other to deform the dose, shaping it according to the desired geometry.

The apparatuses of this type, such as, for example, the one described in patent document WO 2020/075020 A1 in the name of the same Applicant as this invention, have a series of transport elements mounted along a circular path defined by the carousel and configured for severing the dose from the extruder, retaining it along the above-mentioned circular path and releasing it above the male element.

These elements are configured in the form of a blade which defines a flat surface for retaining the dose and an upper cutting edge configured for removing the dose from the extruder.

For that purpose, the blade may also be equipped with a series of suction holes for retaining the dose in a stable manner during its movement along the circular path.

The blade is mounted in a movable fashion on the carousel between two operating configurations: a first raised configuration for picking up the dose and a second lowered configuration for releasing the dose.

In the first picking up configuration the blade is oriented in such a way as to position the surface facing the dose at the outlet from the extruder and with a planar extension perpendicular to the advancement direction along the circular path. Typically, the extruder feeds the dose downwards to allow the advancing blade to intercept the dose with the respective flat surface. In this case, the cutting edge faces towards the extruder in order to remove the dose from the outfeed nozzle of the extruder.

It should be noted that the dose at the outfeed from the extruder is in a semi-solid form obtained by heating the polymeric material upstream of the extrusion nozzle.

For this reason, thanks to the semi-solid structure (molten material), the dose remains attached to the flat surface of the blade, remaining engages engaged with it during the respective transportation step.

Moreover, the sucking action through the holes facilitates retaining the charge on the flat surface of the blade.

After picking up the dose, the blade is lowered into the second release configuration. In this position, the surface is oriented with the planar extension coinciding with the advancement direction of the circular path and facing the male moulding element. Moreover, in this situation the dose faces downwards.

Consequently, the dose is positioned by falling on the above-mentioned male element. The release of the dose is also facilitated by interrupting the suction through the holes, thus leaving the dose to detach by gravity from the respective surface.

Once the dose has been released in the moulding station, the blades are fed along the circular path wherein they are returned to the above-mentioned first picking up condition in order to pick up a new dose.

However, the prior art apparatuses described above have some drawbacks linked mainly to the plastic nature of the dose.

It should be noted that by thermal inertia the dose, after being picked up, keeps the heat so as to be in a semi-solid state suitable for moulding.

In this situation, the chemical nature of the polymeric material is such as to define a stable adhesion with the flat surface, making the relative detachment difficult for the release into the mould.

In other words, the polymeric material leaving the extruder is considerably hot and tends to stick to the surface of the blade, with the consequent disadvantages during the subsequent releasing steps. In effect, in this case, only the movement of the blade and the interruption of the suction action is insufficient to make the dose fall in an optimum and precise manner on the male element of the moulding means.

In addition to the above, it should also be noted that the blade upstream of the extruder is still hot due to the presence of the dose just released, thus favouring the gluing on the flat surface of a new dose.

This situation is determined by the heat exchange effect by conduction between the dose and the blade. Once the dose has been released, the blade which absorbed heat from the dose is immediately returned to the extruder, thus preventing a return to ambient temperature.

In this situation, the aim of the invention is to provide an apparatus and a method which are able to overcome the above mentioned drawbacks of the prior art.

More specifically, the aim of the invention is to provide an apparatus and a method wherein each dose can be correctly positioned in the moulding devices.

Another aim is to provide an apparatus and a method which are able to correctly move the dose, both during the relative steps for picking up from the extruder and for transferring and releasing the dose.

Yet another aim of the invention is to adjust the temperature of the means for retaining the dose at least during the steps for picking up the dose.

According to the invention, there is an comprising: a dispensing device for dispensing doses of polymeric material in a form suitable for compression moulding; a mould for receiving said doses and making concave objects; a plurality of transport elements of respective doses, each of which configured for picking up the respective dose from the dispensing device and releasing it to said mould; a carousel for supporting said transport elements for feeding each element in an advancement direction and along a closed path passing between the dispensing device and the mould, so as to bring the dose to the mould; wherein each transport element comprises a wall for engaging the dose rotatably mounted on the carousel between a picking up condition wherein the wall has a respective surface for contact with the dose transversal to the advancement direction to intercept and pick up the dose from the dispensing device, and a condition for releasing the dose wherein the wall is overturned with the contact surface facing the mould for releasing the dose in the mould by gravity; and wherein it comprises cooling means of each transport element for cooling said transport element at least in a zone of the closed path.

In this way, the pick-up element can dissipate the heat carried by the dose made of molten material, thereby preventing any gluing of the dose on the element.

Preferably, the said cooling means comprise at least one unit for blowing a flow of cooling air, for directing said flow towards the wall of the pick-up element in the respective release condition; the wall in the release condition having a planar extension facing the blowing unit to be cooled by the unit upstream of the dispensing device.

In this situation, the blowing unit advantageously has a manifold having an arc-shaped extension parallel to at least one stretch of the closed path interposed between the mould and the dispensing device in the advancement direction of the transport elements; said manifold having at least one nozzle for discharging said flow of cooling air towards said wall.

In this way, the wall of each transport element is cooled upstream of the dispensing device in order to pick up the dose in an optimum temperature condition.

Advantageously, the cooling means comprise in addition or alternatively a duct for passage of a cooling fluid formed inside said engagement wall for cooling the wall along the circumferential path and in the respective pick-up and/or release conditions.

In this way, a source for supplying the cooling fluid is in fluid communication with an inlet stretch of the wall through a channel for feeding cold air formed in the carousel; the channel allows cold air to flow to the inlet stretch during the entire closed path of the transport element.

Advantageously, the elements are always cooled in order to control the temperature of the wall even when it engages the dose in the molten state. Alternatively, the feed channel may have at least one arc-shaped portion corresponding to a respective angular sector of the closed path; the feed channel allows the passage of cold air towards the inlet stretch only when the element is at the angular sector of said closed path.

In this way, one or more zones of the closed path in which to thermally condition the pick-up element may be selected in order to re-establish an optimum temperature of the wall which moves the dose.

The invention also comprises a method comprising the steps of: dispensing in succession doses of polymeric material in a form suitable for compression moulding from a dispensing device; picking up the doses from the dispensing device by means of respective transport elements mounted on a rotary carousel; feeding the elements in an advancement direction and along a closed path from the dispensing device to a mould; releasing the dose in said mould to make a concave object; wherein it also comprises the step of cooling each transport element during the step of feeding the elements and at least in a zone of the closed path.

The cooling step is advantageously actuated by blowing at least one flow of air towards a wall of each element configured to engage the dose.

In addition or alternatively, the step of cooling the transport elements is actuated by distributing a cooling fluid inside a wall of each element configured for engaging the dose.

Thanks to the cooling steps, which may be actuated from the outside of the carousel, by blowing the air flow towards the walls of the pick-up elements and/or inside the wall, directing a cooling fluid in channels made in the walls. In the latter case, the cooling action may be constant along the entire path of the elements along the closed path or only at one or more stretches of the path.

The invention can be better understood and implemented with reference to the accompanying drawings which illustrate a non-limiting example embodiment of it and wherein:

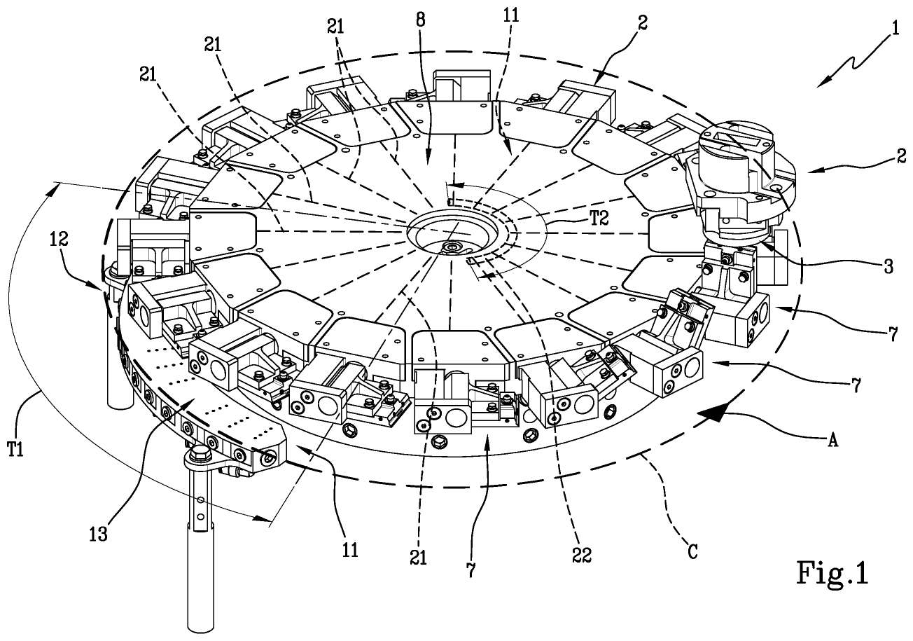

FIG. 1 is a perspective view from above of an apparatus for compression moulding concave objects;

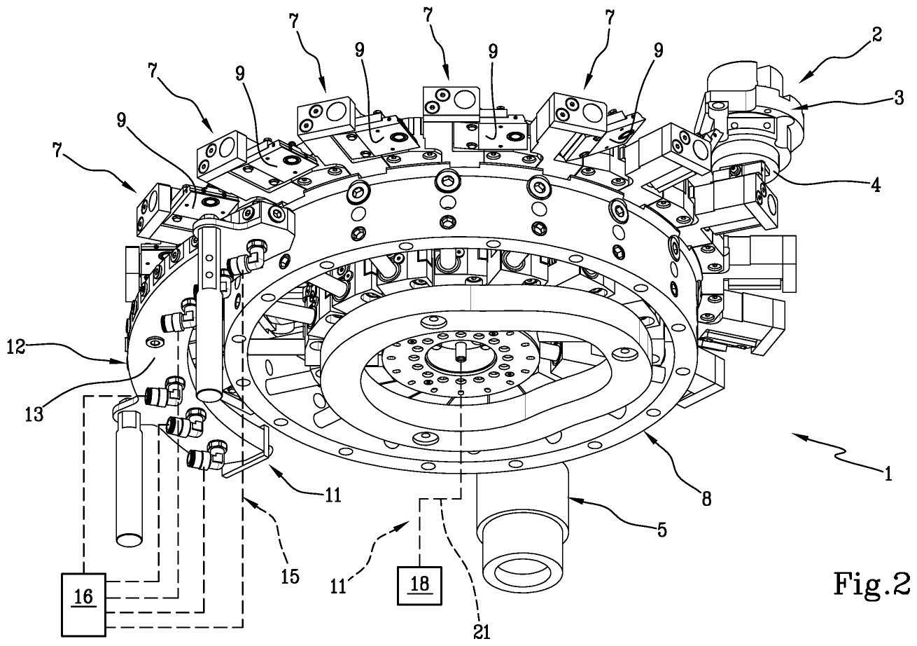

FIG. 2 is a perspective view from below of the apparatus of FIG. 1;

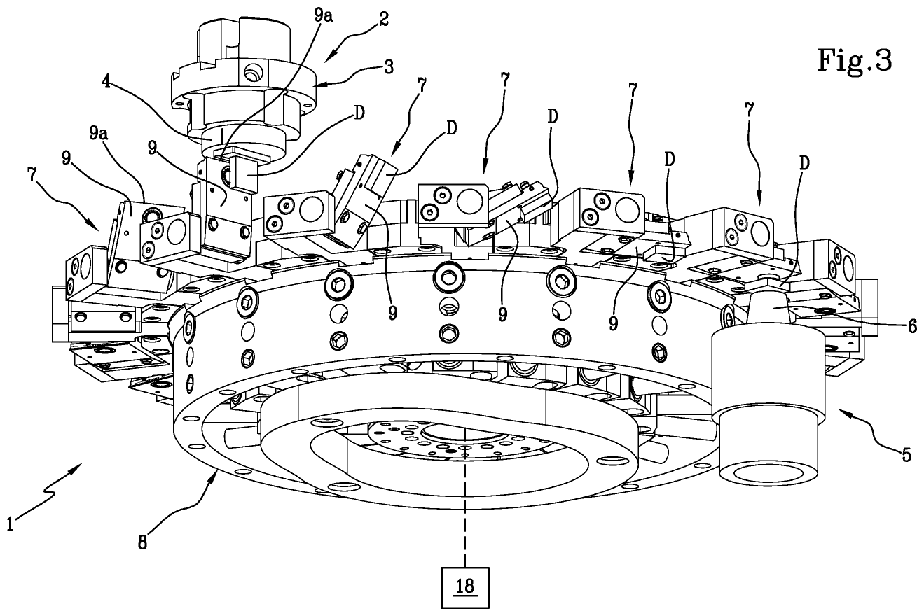

FIG. 3 is a perspective and side view of the apparatus of FIG. 1;

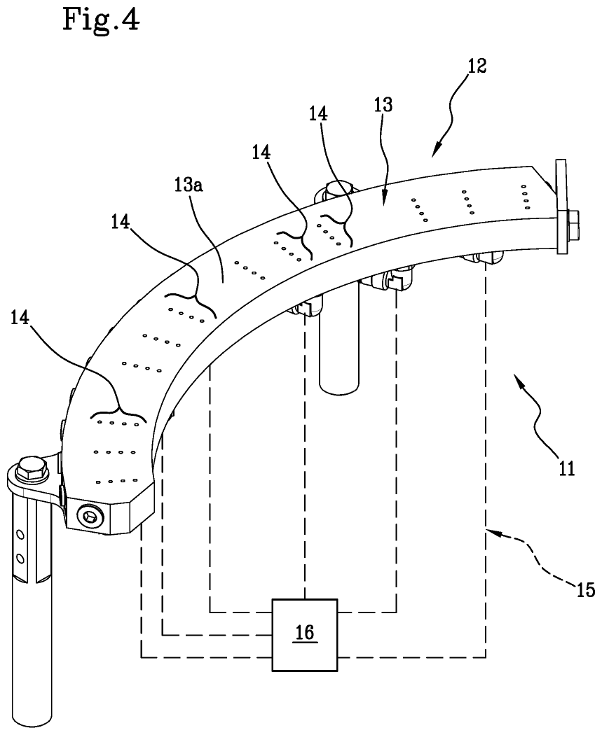

FIG. 4 is an enlarged perspective view of a construction detail of the apparatus of FIG. 1;

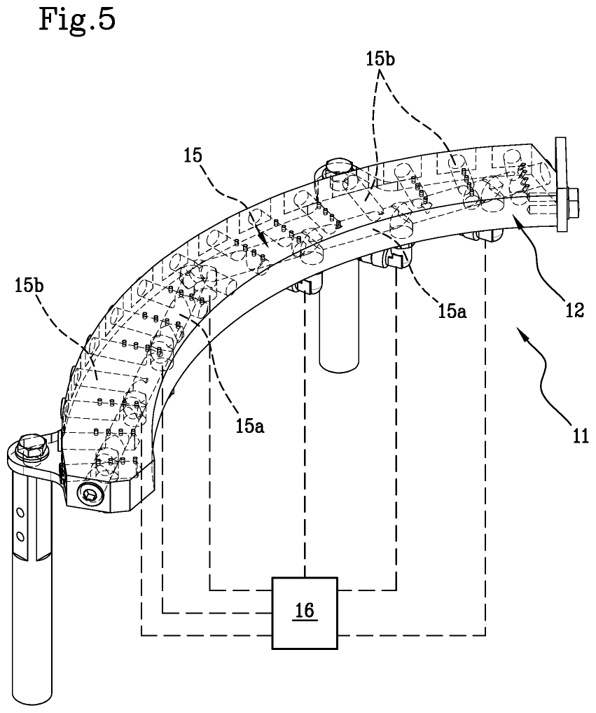

FIG. 5 is a perspective view of the detail of FIG. 4 with some parts transparent in order to better illustrate the internal structure;

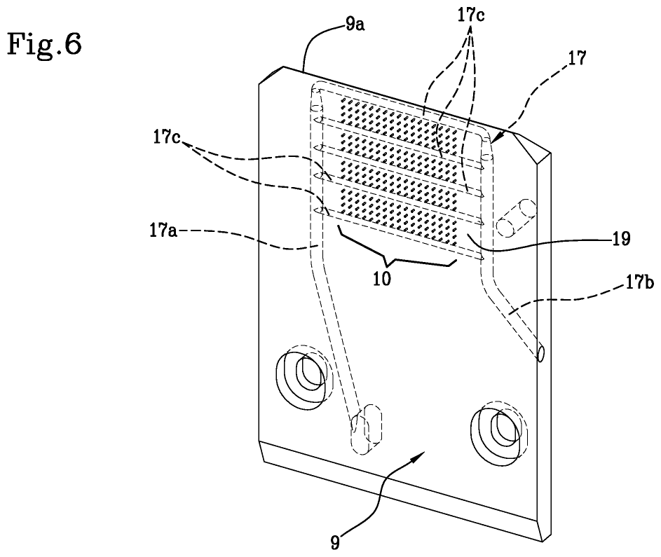

FIG. 6 is a perspective view of another construction detail of the apparatus, with some parts transparent in order to better illustrate the internal structure of the detail;

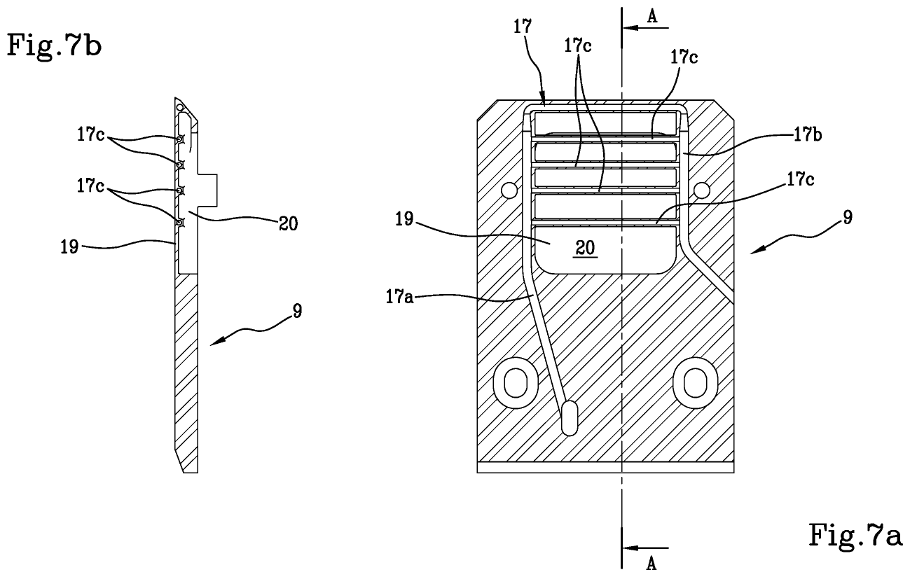

FIG. 7a is a side view and transversal cross section of the detail of FIG. 6; and

FIG. 7b is a side view and longitudinal cross section along the line A-A of FIG. 7a.

FIG. 1 shows an apparatus 1 for producing objects made of polymeric material by compression moulding. The objects which the apparatus 1 allows production of may be concave objects, particularly containers, such as, for example, capsules for coffee or jars, glasses, bottles or bowls.

Alternatively, the apparatus 1 may be used for producing parisons designed to form containers by blow-moulding.

The apparatus 1 comprises a dispensing device 2 for dispensing at least one polymeric material. In the example shown, the dispensing device 2 comprises an extrusion device 3 for dispensing a continuous extruded structure comprising a polymeric material or several layers of polymeric material different to each other.

The extrusion device 3 may comprise an extrusion head 4 from which a dose “D” of polymeric material comes out in a form suitable for compression moulding. In particular, the dose “D” is in the molten, or at least partly molten, state and therefore semi-solid. The dose “D” at the outfeed from the extrusion head 4, which is illustrated schematically in FIG. 4, therefore has a predetermined temperature designed to keep the polymeric material in its viscous form suitable for the subsequent compression moulding step. Downstream of the dispensing device 2 a mould 5 extends for receiving the doses “D” and making the above-mentioned objects. The mould 5 is schematically illustrated in the form of a male punch 6 defining a surface for supporting the dose “D”. The male punch 6 is configured to be coupled to a female element (not illustrated in the drawings) suitably shaped to match in order to compress the dose “D” thereby obtaining the object which must be made. For this purpose, the dose “D” must be positioned on the punch 6 in a precise manner and always at a predetermined temperature which ensures the semi-solid structure suitable for compression moulding.

The doses “D” are fed from the device 2 to the mould 5 by means of a series of transport elements 7, mounted aligned along the periphery of a supporting carousel 8 rotatable about a respective axis of rotation “X”. The carousel 8 feeds each transport element 7 in an advancement direction “A” and along a closed path “C”, preferably circular, passing between the dispensing device 2 and the mould 5.

Advantageously, each transport element 7 is configured for picking up a respective dose “D” from the dispensing device 2 and releasing it on the punch 6 of the mould 5.

More specifically, each transport element 7, during its advance along the path “C” intercepts the dose “D” coming out from the head 4 for advancing the dose towards the mould 5 (FIG. 3). Once the dose has been released on the punch 6, the transport element 7 is carried along the path “C” to be again moved to the dispensing device 2 where it intercepts a new dose “D”. Preferably, each transport element 7 comprises a wall 9 for engaging the dose “D” designed to be in contact with the dose “D” and to retain it during the movement along the path “C”.

The wall 9 is preferably flat and may be provided (as illustrated in FIG. 6) with a series of suction holes 10 which favour the retaining of the dose “D”. In this situation, the holes 10 are in fluid connection with a suction source configured to suck air and define a negative pressure at the wall 9 precisely for favouring the retaining of the dose “D”. The holes 10 may also be provided for blowing air in order to facilitate the steps of extracting and severing the dose “D” from the wall 9.

In this case, once the mould 5 has been reached, the holes allow the passage of a jet of air towards the outside which pushes the dose “D” to detach from the wall 9 for positioning on the punch 9.

Each transport element 7 is also rotatably mounted on the carousel 8 between a picking up condition wherein the wall 9 has a contact surface 9a with the dose “D” oriented transversely to the advancement direction “A” (better illustrated in FIG. 3), and a condition for releasing the dose “D” wherein the wall 9 is overturned with the contact surface 9a facing the mould 5 (better illustrated in FIG. 2). Advantageously, in the picking up condition the wall 9 intercepts and removes the dose “D” from the dispensing device 2, whilst in the release position the wall 9 lets the dose “D” fall into the mould 5.

In other words, the element 7 is suitably rotated by 90° by means of movement systems, such as, for example, a cam system mounted on the carousel, for positioning the wall 9 facing the dose “D”, and for lowering the wall 9 at the mould 5 facing the punch 6.

It should be noted that the wall 9 has a planar extension and that in the picking up condition in which it faces the dose “D” it severs the dose “D” from the rest of the material being extruded by means of an upper cutting edge of the wall 9.

It should also be noted that the wall 9 is positioned in the picking up condition only when close to the dispensing device 2 to be immediately lowered when close to the mould 5. For this reason, for most of the path “C” which each element 7 moves along, the wall 9 is positioned in the release condition in which the flat surface 9a faces downwards. It should be noted in this regard that the walls 9 in the release condition are all positioned coplanar with each other and facing downwards.

The apparatus 1 also comprises means 11 for cooling each transport element 7 to cool the transport element 7 at least in a zone of the closed path “C”.

More specifically, in accordance with a first embodiment of the invention, the cooling means 11 comprises at least one blowing unit 12 positioned in front of the carousel to generate a flow of cooling air.

As illustrated in more detail in FIGS. 1 and 2, the flow of air is directed towards the wall 9 of each element 7 in the respective release condition. In effect, in this case, the walls 9 in the release conditions have a planar extension facing the blowing unit 12 so that they are struck by the flow of air. Advantageously, the flow of air cools the walls 9 upstream of the dispensing device 2, that is to say, before each wall 9 picks up a dose “D”. Advantageously, with reference in particular to FIGS. 2, 4 and 5, the blowing unit 12 has a box-shaped collector 13, having an arc-shaped profile parallel to at least one stretch “T1” of the closed path “C” interposed between the mould 5 and the dispensing device 2 in the advancement direction “A” of the transport elements 7.

The manifold 13 has an upper surface 13a facing the transport elements 7 which slide at the above-mentioned stretch T1 and having at least one nozzle 14 for discharging the flow of cooling air.

Preferably, there is a plurality of nozzles 14 spaced from each other and aligned along the above-mentioned arc-shaped stretch “T1” for dispensing respective flows of air towards the walls 9 of the respective elements 7 in a homogeneous manner along the stretch “T1” of the closed path “C” interposed between the mould 5 and the dispensing device 2 in the advancement direction “A”.

It should be noted that at the above-mentioned stretch “T1” the walls 9 of the elements 7 are oriented in the respective release condition (FIG. 2). In effect, in this situation, the walls 9 of the elements 7 which advance in the stretch “T1” have an extension coplanar with each other and face the upper surface 13a of the manifold 13 so as to be struck by the flow of cooling air. The flow of air is cooled by a water heat exchanger 16, illustrated only schematically in FIGS. 4 and 5, for supplying pressurised cooled air at a predetermined temperature inside the manifold.

For this purpose, the manifold 13 is advantageously provided internally with a duct 15 for the passage of the cooling air, for putting the heat exchanger 16 in fluid communication with the nozzles 14.

The passage duct 15 comprises a main branch 15a which extends longitudinally along the manifold 13, and a series of auxiliary branches 15b which branch from the main duct 15a towards the respective nozzles 14. The main branch 15a is also connected to the heat exchanger 16 by suitable pneumatic passages which are schematically illustrated in the accompanying drawings. It should be noted in this regard that the pneumatic path illustrated in the accompanying drawings is shown solely by way of a non-limiting example. The pneumatic passages may therefore be connected to any portion of the passage duct 15.

In addition, or alternatively to the above, the cooling means 11 also comprise a duct 17 for the passage of a cooling fluid formed inside the wall 9 of each transport element 7.

The passage duct 17 feeds the fluid in such a way as to cool the inside of the wall 9 whilst it is fed along the circumferential path “C” and in the respective pick-up and/or release conditions.

In particular, as better illustrated in FIGS. 6, 7a, 7b, the passage duct 17 comprises: an inlet stretch 17a configured for feeding the cooling fluid from a supply source 18 towards the inside of the wall 9; an outlet stretch 17b for the fluid heated inside the wall 9 configured so that the hot fluid flows towards the outside of the wall 9; and a plurality of heat exchange stretches 17c extending between said inlet stretch 17a and outlet stretch 17b. In this way, the fluid in the exchange stretches 17c absorbs the heat transferred by the wall 9 to lower the temperature of the wall 9.

Consequently, the cold fluid in the inlet stretch 17a is heated at the heat exchange stretches 17c and then made to flow out of the wall 9 from the outlet stretch 17b.

Advantageously, the heat exchange stretches 17c are parallel to each other and extend in a zone of the wall 19 corresponding to the zone for coupling with the dose “D”.

In other words, the heat exchange stretches 17c are housed in the zone 19 of the wall in which the dose “D” is engaged by the wall 9. The zone 19 is advantageously provided with the above-mentioned suction and/or blowing holes 10. It should be noted from the cross-section views in FIGS. 7a and 7b that the zone 19 is determined by a cavity 20 of the wall 9 which defines a reduced cross section wherein the thickness of the wall 9 is much less in order to facilitate heat exchange with the cooling fluid.

Consequently, in the condition for picking up and retaining the dose “D”, the heat transferred to the wall 9 from the dose “D” is absorbed by the flow fluid in the heat exchange ducts 17c, with the consequent control of the temperature of the wall 9 which is cooled.

Advantageously, the cooling fluid may be a cooling liquid.

The supply source 18, illustrated schematically in FIGS. 2 and 3, preferably comprises a water heat exchanger in fluid communication with the inlet stretch 17a and the outlet stretch 17b in such a way as to cool the fluid coming from the outlet stretch 17b (hot) and feed cooled fluid to the inlet stretch 17a.

For this purpose, the supply source 18 is in fluid communication with the inlet stretch 17a by means of a series of channels 21 for feeding cold fluid made in the carousel 8 and illustrated only schematically (FIG. 1).

In this way, each channel 21, which extends radially from the centre of the carousel in which it is connected with the source towards the respective element 7, allows the passage of cold fluid to each inlet stretch 17a made in the respective walls 9 during the entire closed path “C” along which the transport elements 7 move.

Advantageously, the walls 9 are constantly conditioned thermally and kept stably at an optimum temperature, dissipating the heat generated by the doses “D”.

According to a further embodiment of FIG. 1, there is also at least one curved cavity 22 corresponding to a respective angular sector “12” of the closed path “C”. The arched cavity 22 is made in a fixed zone of the carousel 8 so as to always be in fluid connection with the source 8 and selectively connectable to the channels 21 only at the passage of the respective element 7 at the above-mentioned angular sector “12”.

In other words, the inlet channel 21 allows the passage of cold fluid from the source 18 to the inlet stretch 17a only when the respective channel 21 is placed in communication with the cavity 22.

In this way, the internal cooling of the wall 9 occurs only when the element 7 passes the angular sector T2 and therefore only in a portion of the closed path “C”.

Preferably, there may be two or more cavities 22 for cooling each wall 9 at two or more times while the respective element 7 is being fed along the path “C”.

The position and size of each curved cavity 22 therefore determines the position and duration of the cooling action of the wall 9. FIG. 1 shows by way of example a single cavity 22 which allows the passage of the cooling fluid at the device 2 and the mould 5 (angular sector “12”). It should be noted, however, that the cavity 22 may have any position or length depending on the specific cooling action of the wall 9.

According to an alternative embodiment of the invention, the cooling means 11 may consist of the system for distributing the suction and blowing air of the doses “D”. In this situation, the suction/blowing air which passes through the holes 10 is also used for the thermal conditioning and for providing, in a stretch between the mould 5 and the dispensing device 2 of the doses “D”, an action for cooling the wall 9.

The invention also relates to a method for compression moulding objects made of polymeric material. The method comprises the following steps:
dispensing in succession doses “D” of polymeric material in a shape suitable for compression moulding from a dispensing device 2;
picking up the doses “D” from the dispensing device 2 using respective transport elements 7 mounted on a rotary carousel 8;
feeding the elements 7 in an advancement direction A and along a closed path “C” from the dispensing device 2 to a mould 5,
releasing the dose in the mould 5 to make a concave object;
wherein it also comprises the step of cooling each transport element 7 during the step of advancing the elements 7 and at least in a zone T1, T2 of the closed path “C”.

In particular, the step of cooling the transport elements 7 is actuated by blowing at least one flow of air towards a wall 9 of each element 7 configured to engage and retain the dose “D”.

The step of blowing a flow of air is actuated by dispensing a plurality of jets of pressurised air positioned aligned along an arc-shaped stretch “T1” of the path “C” interposed between the mould 5 and the dispensing device 2 in the advancement direction “A” of the transport elements 7.

The flows of air are dispensed towards the walls 9 of the transport elements 7 whilst they are oriented in a respective release condition of the dose “D”. Advantageously, in the release condition, the walls 9 are overturned with a planar extension parallel to the advancement direction “A” along the path “C”. Moreover, in the release condition, the walls 9 are coplanar with each other so as to face the flows of air which strike the surface of each wall 9. Advantageously, it should be noted that the cooling action is performed upstream of the dispensing device 2 and thus before the step of picking up the dose “D”. In this way, each wall 9 is thermally conditioned (cooled) for picking up and retaining the dose “D” in an optimum condition from the thermal point of view, resulting in the cooling also of the dose “D”.

In addition, or alternatively to what is described above, the step of cooling the transport elements 7 is actuated by distributing a cooling fluid inside the wall 9 of each element 7.

In this case, the cooling thermal flow does not strike the wall 9 from the outside as described above but is distributed inside the wall 9.

Preferably, the step of distributing the cooling fluid in the wall 9 is actuated by feeding the fluid through a plurality of heat exchange stretches 7c made inside the wall 9 to allow the fluid to absorb the heat transferred from the dose D through the wall 9 and therefore reduce the temperature of the wall 9.

In accordance with an embodiment of the invention, the step of cooling inside the wall 9 is actuated constantly, during the advancement of the elements 7 along the entire circumferential path “C” and in the respective conditions both for picking up and releasing the dose “D”.

Alternatively, according to a further embodiment, the step of distributing the cooling fluid in the wall 9 is actuated during the passage of each element 7 at least at one angular sector “T2” of the closed path “C”. In this way, the wall 9 is cooled for a length of time which may be simultaneous with the step of picking up and depositing the dose “D” or before the step of picking up the dose “D”.

The invention therefore overcomes the drawbacks of the prior art and brings important advantages.

Firstly, it should be noted that the wall 9 of the transport element 7 is thermally conditioned in order to absorb part of the heat of the dose “D” extruded in a semi-solid form.

In this way, the temperature of the cooled wall 9 allows the temperature of the dose “D” to be also lowered, keeping it in any case in the semi-solid state suitable for compression moulding but avoiding adhesion to the wall 9.

For this reason, the cooling action of the wall 9, which also determines the cooling of the dose “D”, allows the facilitated detachment of the dose “D” by only moving the wall 9 and, if necessary, interrupting the suction. The dose “D” may therefore be positioned on the punch 6 in an optimum manner and with precision.

Moreover, the apparatus is extremely versatile since it is able to cool the wall 9 from the outside, by the air flowing out of the manifold 13 and/or by means of the internal cooling of the wall 9.

It is also possible to determine the cooling zone during the path “C” as a function of the specific requirements, the nature of the polymeric material and the tendency of the material in the molten state to adhere to the wall 9.

1. An apparatus comprising:
a dispensing device (2) for dispensing doses (D) of polymeric material in a shape suitable for compression moulding;
a mould (5) for receiving said doses (D) and making concave objects;
a plurality of elements (7) for transporting respective doses (D), each of which configured for picking up the respective dose (D) from the dispensing device (7) and releasing the doses to said mould (5);
a carousel (8) for supporting said transport elements (7) for feeding each element (7) in an advancement direction (A) and along a closed path (C) passing between the dispensing device (2) and the mould (5), so as to move the dose (D) to the mould (5);
wherein each transport element (7) comprises a wall (9) for engaging the dose (D) rotatably mounted on the carousel (8) between a picking up condition wherein the wall (9) has a respective surface (9a) for contact with the dose (D) transversal to the advancement direction (A) to intercept and pick up the dose (D) from the dispensing device (2), and a condition for releasing the dose (D) wherein the wall (9) is overturned with the contact surface (9a) facing the mould (5) for releasing the dose (D) in the mould (5) by gravity;
wherein the apparatus comprises cooling means (11) of each transport element (7) for cooling said transport element (7) at least in a zone (T1, T2) of the closed path (C).

2. The apparatus according to claim 1, wherein said cooling means (11) comprise at least one unit (12) for blowing a flow of cooling air, for directing said flow towards the wall (9) in the respective release condition; said wall (9) in the release condition having a planar extension facing said blowing unit (12) to be cooled by the unit (12) upstream of the dispensing device (2).

3. The apparatus according to claim 2, wherein said blowing unit (12) has a manifold (13) having an arc-shaped extension parallel to at least one stretch (T1) of the closed path (C) interposed between the mould (5) and the dispensing device (2) in the advancement direction (A) of the transport elements (7); said manifold (13) having at least one nozzle (14) for discharging said flow of cooling air towards said wall (9).

4. The apparatus according to claim 3, wherein the manifold (13) has a plurality of nozzles (14) spaced from each other for dispensing respective flows of air along said stretch (T1) of the closed path (C) interposed between the mould (5) and the dispensing device (2) wherein the walls (9) are in the respective release condition.

5. The apparatus according to claim 4, wherein said cooling means (11) comprise a water heat exchanger (16) for cooling the air upstream of the manifold (13); said manifold (13) having internally a duct (15) for passage of the cooling air for putting in fluid communication the heat exchanger (16) with said nozzles (14).

6. The apparatus according to claim 1, wherein said cooling means (11) comprise a plurality of holes (10) for the suction and/or blowing of the dose (D) made in the contact surface (9a); said holes allowing the passage of air to cool the wall (9) during the suction and/or blowing of the dose (D).

7. The apparatus according to claim 1, wherein said cooling means (11) comprise a duct (17) for the passage of a cooling fluid formed inside said wall (9) for cooling the wall (9) along the circumferential path (C) and in the respective pick-up and/or release conditions.

8. The apparatus according to the claim 1, wherein said passage duct (17) comprises: an inlet stretch (17a) for feeding the cooling fluid from a source (18) for supplying the fluid inside the wall (9); an outlet stretch (17b) for the fluid heated inside the wall (9) so that the fluid flows out towards the outside of the wall (9); and a plurality of heat exchange stretches (17c) extending between said inlet stretch (17a) and outlet stretch (17b); said fluid in the heat exchange stretches (17c) absorbing the heat transferred from the dose (D) to reduce the temperature of the wall (9).

9. The apparatus according to claim 8, wherein said heat exchange stretches (17c) are parallel to each other and extend in a zone (19) of the wall (9) in which the dose (D) is in contact.

10. The apparatus according to claim 8, wherein said supply source (18) comprises a water heat exchanger in fluid communication with the inlet stretch (17a) and the outlet stretch (17b) for cooling the fluid coming from the outlet stretch (17b) and feeding the cooled fluid to said inlet stretch (17a).

11. The apparatus according to claim 8, wherein said supply source (18) is in fluid communication with the inlet stretch (17a) through a channel (21) for feeding the cold fluid formed in the carousel; said channel (21) allowing the passage of cooled fluid to the inlet stretch (17a) during the entire path (C) of the transport element (7).

12. The apparatus according to claim 8, wherein said supply source (18) is in fluid communication with the inlet stretch (17a) through a channel (21) for feeding cold fluid made in the carousel; wherein said feed channel has at least one curved cavity (22) corresponding to a respective angular sector (T2) of the path (C); said feed channel (21) allowing the passage of cooled fluid towards the inlet stretch (17a) only when the element (7) is at the angular sector (T2) of said closed path (C).

13. A method comprising:
dispensing in succession doses (D) of polymeric material in a shape suitable for compression moulding from a dispensing device (2);
picking up the doses (D) from the dispensing device (2) using respective transport elements (7) mounted on a rotary carousel (8);
feeding the elements in an advancement direction (A) and along a closed path (C) from the dispensing device (2) to a mould (5);
releasing the dose (D) in said mould (5) to make a concave object;
wherein the method also comprises the step of cooling each transport element (7) during the step of advancing the elements (7) and at least in a zone (T1, T2) of the closed path (C).

14. The method according to claim 13, wherein said step of cooling the transport elements (7) is actuated by blowing at least one flow of air towards a wall (9) of each element (7) configured to engage the dose (D).

15. The method according to claim 14, wherein the step of blowing a flow of air is actuated by dispensing a plurality of jets of pressurised air positioned aligned along an arc-shaped stretch (T1) of the path (C) interposed between the mould (5) and the dispensing device (2) in the advancement direction (A) of the transport elements (7).

16. The method according to claim 15, wherein said flows of air are dispensed towards the walls (9) of the transport elements (7) oriented in a condition for releasing the dose (D) wherein the walls (9) are overturned with a planar extension parallel to the advancement direction (A).

17. The method according to claim 13, wherein said step of cooling the transport elements (7) is actuated by distributing a cooling fluid inside a wall (9) of each element (7) configured to engage the dose (D).

18. The method according to claim 17, wherein said cooling step is actuated during the advancement of the elements (7) along the circumferential path (C) and in the respective pick-up and/or release conditions.

19. The method according to claim 18, wherein said step of distributing the cooling fluid in the wall (9) is actuated by feeding said fluid through a plurality of heat exchange stretches (7c) made inside the wall (9) to allow the fluid to absorb the heat transferred from the dose (D) and reduce the temperature of the wall (9).

20. The method according to claim 18, wherein said step of distributing the cooling fluid in the wall (9) is actuated during the entire closed path (C) of each transport element (7).

21. The method according to claim 18, wherein said step of distributing the cooling fluid in the wall (9) is actuated during the passage of each element (7) at least at one angular sector (T2) of said path (C).
